(19) United States
(12) Patent Application Publication
(10) Pub. No.: US 2017/0017874 A1
(43) Pub. Date: Jan. 19, 2017

(54) RADIO FREQUENCY IDENTIFICATION (RFID) READER WITH FREQUENCY ADJUSTMENT OF CONTINUOUS RADIO FREQUENCY (RF) WAVE

(71) Applicant: QUALCOMM Incorporated, San Diego, CA (US)

(72) Inventor: Edwin Chongwoo PARK, San Diego, CA (US)

(21) Appl. No.: 15/148,023

(22) Filed: May 6, 2016

Related U.S. Application Data
(60) Provisional application No. 62/193,297, filed on Jul. 16, 2015.

(51) Int. Cl. G06K 19/077; G06K 19/07

(52) U.S. Cl. CPC G06K 19/07796; G06K 19/0724

(57) ABSTRACT

A method of communicating by a Radio Frequency Identification (RFID) reader includes transmitting, by the RFID reader, a continuous radio frequency (RF) wave at a first frequency. The method also includes adjusting, by the RFID reader, the first frequency of the continuous RF wave to a second frequency and then receiving a backscattered RF wave at the first frequency from an RFID tag. The backscattered RF wave is generated by the RFID tag in response to the continuous RF wave of the first frequency. A difference between the first frequency and the second frequency is equal to or greater than a frequency difference threshold to reduce interference between the backscattered RF wave and the continuous RF wave.

### TECHNICAL FIELD

The various aspects and embodiments described herein generally relate to radio frequency (RF) communications, and more particularly, to communications by a Radio Frequency Identification (RFID) reader.

### BACKGROUND

Radio Frequency Identification (RFID) systems typically include RFID readers, also known as RFID reader/writers or RFID interrogators, and RFID tags. RFID systems can be used in many ways for locating and identifying objects to which the tags are attached, as well as reading and/or writing information to/from the tags. RFID systems are particularly useful in product-related and service-related industries for tracking objects being processed, inventoried, or handled. In such cases, an RFID tag is usually attached to an individual item, or to its package.

RFID techniques entail using an RFID reader to interrogate one or more RFID tags. The reader transmits a Radio Frequency (RF) wave to perform the interrogation. The RF wave may encode one or more commands that instruct the tags to perform one or more actions.

An RFID tag that senses the interrogating RF wave responds by transmitting back another RF wave. The RFID tag generates the RF wave either originally, or by reflecting back a portion of the interrogating RF wave in a process known as backscatter. Typically, most RFID tags backscatter the interrogating RF wave (e.g., energy from the RFID reader), and very few RFID tags generate their own energy. Thus, the transmitting of an RF wave by the RFID tag typically includes the RFID backscattering a portion of the interrogating RF wave.

The RF wave generated by the RFID tag may include a message that is encoded with data stored in the tag, such as a number. The RF wave is then received by the RFID reader, where the message is demodulated and decoded by the RFID reader, which thereby identifies, counts, or otherwise interacts with the associated item. The decoded data can denote a serial number, a price, a date, a time, a destination, an encrypted message, an electronic signature, other attribute(s), any combination of attributes, and so on. The data items are sometimes known as codes. Accordingly, when a reader receives tag data (codes) it can learn about the item that hosts the tag and/or about the tag itself.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to one aspect, a method of communicating by a Radio Frequency Identification (RFID) reader includes transmitting, by the RFID reader, a continuous radio frequency (RF) wave at a first frequency. The method also includes adjusting, by the RFID reader, the first frequency of the continuous RF wave to a second frequency and then receiving a backscattered RF wave at the first frequency from an RFID tag. The backscattered RF wave is generated by the RFID tag in response to the continuous RF wave of the first frequency. A difference between the first frequency and the second frequency is equal to or greater than a frequency difference threshold to reduce interference between the backscattered RF wave and the continuous RF wave.

According to another aspect, a Radio Frequency Identification (RFID) reader includes a transceiver that is configured to transmit a continuous radio frequency (RF) wave at a first frequency. The RFID reader is also configured to adjust the first frequency of the continuous RF wave to a second frequency, and then receive a backscattered RF wave at the first frequency from an RFID tag. The backscattered RF wave generated by the RFID tag in response to the continuous RF wave of the first frequency. A difference between the first frequency and the second frequency is equal to or greater than a frequency difference threshold to reduce interference between the backscattered RF wave and the continuous RF wave.

According to yet another aspect, a Radio Frequency Identification (RFID) reader includes means for transmitting a continuous radio frequency (RF) wave at a first frequency. The RFID reader also includes means for adjusting the first frequency of the continuous RF wave to a second frequency, and means for receiving a backscattered RF wave at the first frequency from an RFID tag. The backscattered RF wave is generated by the RFID tag in response to the continuous RF wave of the first frequency, where a difference between the first frequency and the second frequency is equal to or greater than a frequency difference threshold to reduce interference between the backscattered RF wave and the continuous RF wave.

According to another aspect, a non-transitory computer-readable storage medium includes computer-executable instructions recorded thereon, where executing the computer-executable instructions on one or more processors of a Radio Frequency Identification (RFID) reader causes the RFID reader to perform operations. The operations include: (i) transmit a continuous radio frequency (RF) wave at a first frequency; (ii) adjust the first frequency of the continuous RF wave to a second frequency; and then (iii) receive a backscattered RF wave at the first frequency from an RFID tag. The backscattered RF wave is generated by the RFID tag in response to the continuous RF wave of the first frequency, where a difference between the first frequency and the second frequency is equal to or greater than a frequency difference threshold to reduce interference between the backscattered RF wave and the continuous RF wave.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an example high-level system architecture of a wireless communications system with various devices that may include RFID tags, according to various aspects.

FIG. 2 illustrates a simplified diagram of an RFID reader communicating with an RFID tag, according to various aspects.

FIG. 3 illustrates an example transceiver of an RFID reader, according to various aspects.

FIG. 4 illustrates a method of communicating by an RFID reader, according to various aspects.

FIG. 5 illustrates the exchange of messages during a transaction between an RFID reader and an RFID tag, according to various aspects.

FIG. 6 illustrates use of a continuous RF wave by an RFID reader to exchange messages during a transaction between the RFID reader and an RFID tag, according to various aspects.

FIG. 7A illustrates an example of adjusting the frequency of a continuous RF wave based on a sawtooth cycle, according to various aspects.

FIG. 7B illustrates an example of adjusting the frequency of a continuous RF wave in a step-wise manner, according to various aspects.

FIG. 7C illustrates an example of adjusting the frequency of a continuous RF wave by frequency-hopping, according to various aspects.

FIG. 8 illustrates an example of an RFID reader, according to various aspects.

FIG. 9 illustrates an RFID reader that includes various structural components configured to perform functionality, according to various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” perform the described action.

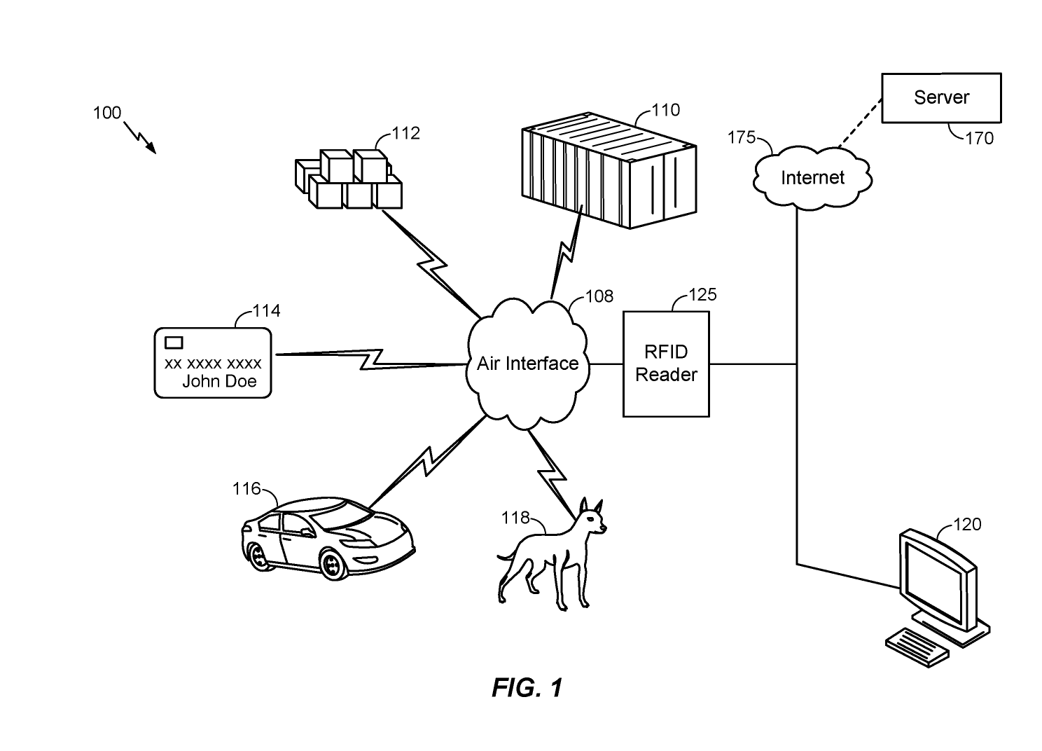

FIG. 1 illustrates an example high-level system architecture of a wireless communications system 100 with various platforms (e.g., 110-118) that may include RFID tags, according to various aspects. The wireless communications system 100 contains a plurality of platforms, which may include a shipping container 110, one or more merchandise/inventory/products 112, an identification/payment card 114, an automobile 116, and an animal/pet 118. Each of the platforms 110-118 may include one or more RFID tags embedded within, attached thereto, or enclosed in the associated packaging of the platform.

RFID reader 125 is configured to communicate with the RFID tags of the platforms 110-118 over a physical communications interface or layer, shown in FIG. 1 as air interface 108. The air interface 108 can comply with one or more RFID standards, such as those set by the International Organization for Standardization (ISO), the International Electrotechnical Commission (IEC), ASTM International, the DASH7 Alliance, and/or EPCglobal. By way of example, air interface 108 may be configured to operate on frequencies known as Industrial Scientific and Medical (ISM) bands. In the United States, for example, the range of frequencies for operation of air interface 108 may be in the range of 902-928 MHz.

The Internet 175 includes a number of routing agents and processing agents (not shown in FIG. 1 for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router (e.g., for a Wi-Fi router with both wired and wireless connectivity). Although illustrated as a desktop computer, computer 120 may be a laptop computer, a tablet computer, a PDA, a smart phone, or the like. The computer 120 may contain functionality to manage a group of platforms containing RFID tags, such as the group of platforms 110-118, based on communications with RFID reader 125. In one aspect, the RFID reader includes in I/O interface for communicating with the computer 120. The I/O interface may include a serial bus interface, such as a Universal Serial Bus (USB) interface for communicating with the computer 120.

The RFID reader 125 may be connected to the Internet 175 via, for example, an optical communication system, such as FiOS, a cable modem, a digital subscriber line (DSL) modem, or the like. The RFID reader 125 may communicate with the respective RFID tags of platforms 110-120 using an RFID protocol over air interface 108 and may communicate with the Internet 175 using the standard Internet protocols (e.g., TCP/IP).

Server 170 is shown as connected to the Internet 175. The server 170 can be implemented as a plurality of structurally separate servers, or alternately may correspond to a single server. In various embodiments, the server 170 may be optional (as indicated by the dotted line), and may contain functionality to manage a group of platforms containing RFID tags, such as the group of platforms 110-118, based on communications with RFID reader 125 via Internet 175.

As mentioned above, each of the platforms 110-118 may include a respective RFID tag. RFID reader 125 may detect, store data received from, communicate with, act on, and/or the like with one or more of the RFID tags present in the wireless communications system 100. For example, automobile 116 may include an RFID tag embedded within or attached thereto (e.g., by way of a decal or pass card). RFID reader 125 may be located on or near a roadway to detect the presence and communicate with the RFID tag to obtain data from the RFID tag. The RFID reader 125 may then pass the data along to computer 120 and or server 170, where the data is used to identify the user of the automobile 116 for performing a variety of tasks, such as charging a user for roadway tolls.

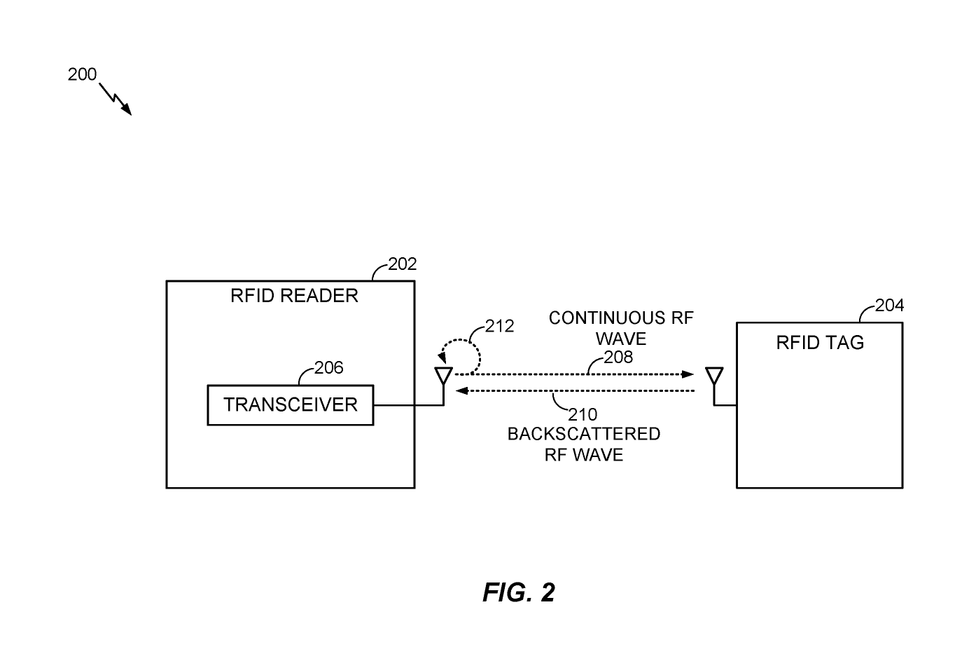

FIG. 2 illustrates a simplified diagram of an RFID reader 202 communicating with an RFID tag 204 in a wireless communications system 200. RFID reader 202 is one possible implementation of RFID reader 125 and RFID tag 204 is one possible RFID tag associated with one of the platforms 110-118.

RFID tag 204 can be either a passive, active, or battery-assisted passive. An active RFID tag has an on-board battery and periodically transmits its ID signal. A battery-assisted passive (BAP) RFID tag has a small battery on board and is activated when in the presence of RFID reader 202. A passive RFID tag is cheaper and smaller because it has no battery; instead, the passive RFID tag uses the radio energy transmitted by the RFID reader 202. However, to operate a passive RFID tag, it must be illuminated with a power level much larger than required for the passive RFID tag to transmit a signal transmission.

RFID Tag 204 may either be read-only, having a factory-assigned serial number that is used as a key into a database, or may be read/write, where object-specific data can be written into the tag by the system user. Field programmable tags may be write-once, read-multiple; “blank” tags may be written with an electronic product code by the user.

RFID tag 204 may contain at least two parts: (1) an integrated circuit for storing and processing information, modulating and demodulating a radio-frequency (RF) signal, collecting DC power from the incident reader signal, and other specialized functions; and (2) an antenna for receiving and transmitting the signal. The tag information may be stored in a non-volatile memory contained in the RFID tag 204. The RFID tag 204 may include either fixed or programmable logic for processing the transmission and sensor data, respectively.

The transceiver 206 of the RFID reader 202 transmits one or more messages by way of a continuous RF wave 208 to energize and interrogate the RFID tag 204. Although FIG. 2 illustrates transceiver 206 as transmitting one continuous RF wave 208, in other aspects the transceiver 206 may be configured to generate multiple continuous RF waves. The RFID tag 204 receives the message and then responds with its identification and other information by generating a backscattered RF wave 210. The identification may be a unique tag serial number, and the other information may be product-related information such as a stock number, lot or batch number, production date, or other specific information. Since RFID tags 204 have individual serial numbers, the RFID reader 202 can discriminate among several tags that might be within the range of the RFID reader 202 and read them simultaneously. A passive RFID tag generates the backscattered RF wave 210 by reflecting back a portion of the continuous RF wave 208 in a process known as backscatter. Thus, the frequency of the backscattered RF wave 210 is determined by the frequency of the continuous RF wave 208. That is, in one example the frequency of the backscattered RF wave 210 is equal to the frequency of the continuous RF wave 208 received at the RFID tag 204.

However, in some instances a portion 212 of the continuous RF wave 208 currently being transmitted by the transceiver 206 of RFID reader 202 and the backscattered RF wave 210 received from the RFID tag 204 are received on the same receive chain of the transceiver 206, thus causing interference. Furthermore, as the range between the RFID reader 202 and RFID tag 204 increases, the RFID reader 202 may attempt to increase the transmit power of the continuous RF wave 208. However, doing so only exasperates the interference problem, as with increased transmit power there will be more leakage power, by way of portion 212 that will go into the receive chain of the transceiver 206. Also, as the range to the RFID tag 204 increases, the propagation loss will be larger. Thus, the signal to tone ratio will be lower (i.e., since transmit power of continuous RF wave 208 is increased and the power of backscattered RF wave 210 decreases due to propagation loss, the ratio of the power of the backscattered RF wave 210 to power of the continuous RF wave 208 is reduced).

Accordingly, aspects of the present disclosure include an RFID reader 202 that is configured to vary the frequency of the continuous RF wave 208. By varying the frequency of the continuous RF wave 208, the backscattered RF wave 210 received at RFID reader 202 may be sufficiently far enough away from the frequency of the continuous RF wave 208 that the RFID reader 202 is currently transmitting so as to reduce interference between the backscattered RF wave 210 and the portion 212 of the continuous RF wave 208 that is also received at the transceiver 206.

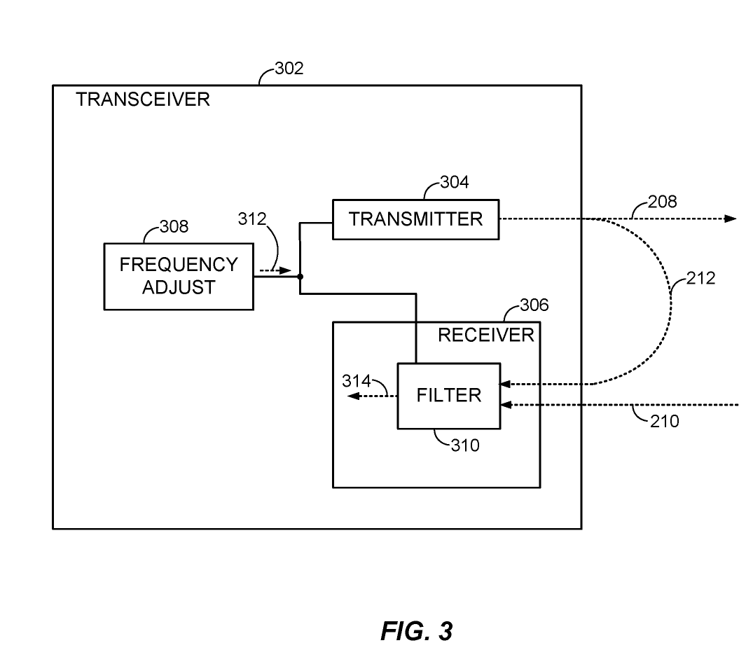

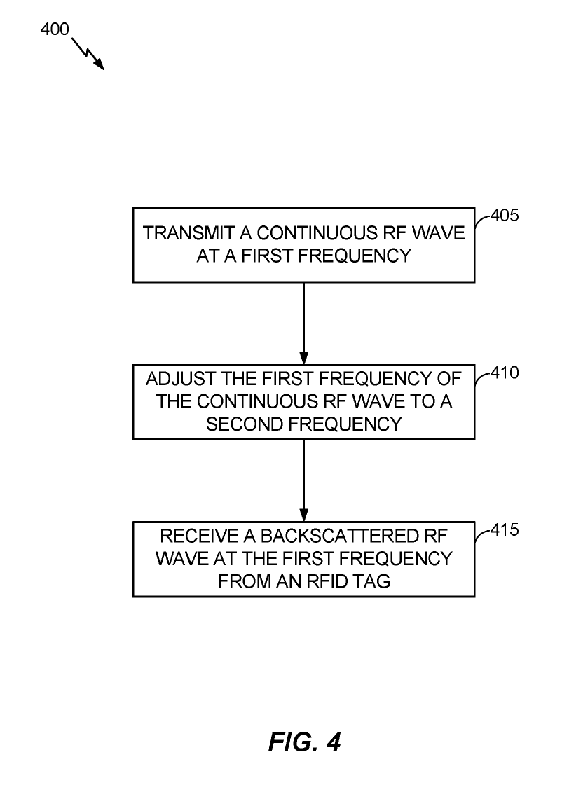

FIG. 3 illustrates an example transceiver 302 of an RFID reader, according to various aspects. Transceiver 302 is one possible implementation of transceiver 206 of FIG. 2. Transceiver 302 is shown as including a transmitter 304, a receiver 306, and a frequency adjust circuit 308. Receiver 306 is also shown as including a filter 310. The operation of transceiver 302 will be described with reference to FIG. 4, which illustrates a process 400 of communicating by an RFID reader, according to various aspects.

In a process block 405, the transmitter 304 of transceiver 302 transmits the continuous RF wave 208 at a first frequency. The transmitting of the continuous RF wave 208 may include transmitting a message, such as a query message, according to one or more RFID protocols. Next, in a process block 410, the transmitter 304 adjusts the first frequency of the continuous RF wave 208 to a second frequency. As shown in FIG. 3, the transmitter 304 may be configured to adjust the frequency of the continuous RF wave 208 in response to a frequency adjust signal 312 generated by frequency adjust circuit 308. As will be discussed in more detail below, the frequency adjust signal 312 may be configured to continuously adjust the frequency of the continuous RF wave 208, for example, based on a sawtooth cycle. In another example, the frequency adjust signal 312 may be configured to adjust the frequency of the continuous RF wave 208 in a step-wise manner. In another example, the frequency adjust signal 312 may be configured to adjust the frequency of the continuous RF wave 208 by randomly selecting a next frequency of the continuous RF wave 208 or by frequency-hopping based on a dynamically determined or previously determined pattern.

In one example, the RFID reader 202 may be configured to determine whether or not to adjust the frequency of the continuous RF wave 208 in response to a transmit power of the continuous RF wave 208. That is, the RFID reader 202 may compare a current transmit power of the continuous RF wave 208 to a power threshold. If the transmit power is greater than or equal to the power threshold, then the RFID reader 202 may proceed with adjusting the frequency of the continuous RF wave 208, as discussed above. However, if the transmit power is less than the power threshold, then the RFID reader may be configured to maintain the continuous RF wave 208 at the first frequency, such that the continuous RF wave 208 is at the first frequency when the backscattered RF wave 210 of the first frequency is received at the receiver 306. In one aspect, the power threshold may correspond to a range between the RFID reader and a respective RFID tag. For shorter ranges, the transmit power may be reduced and propagation delays are shorter. Thus interference may be less of a factor for these shorter ranges.

Next, in process block 415, the receiver 306 receives the backscattered RF wave 210 at the first frequency from an RFID tag (e.g., RFID tag 204). As discussed above, the RFID tag 204 may be a passive or partially passive RFID tag 204 that is configured to generate the backscattered RF wave 210 in response to, and at the same frequency as, the continuous RF wave 208 received at the RFID tag 204.

As shown in FIG. 3, in addition to receiving the backscattered RF wave 210, the receiver 306 may also receive a portion 212 of the continuous RF wave 208 that is currently being transmitted by the transmitter 304. However, as mentioned above, the transmitter 304 is configured to adjust the frequency of the continuous RF wave 208. In one aspect, the adjustment of the frequency of the continuous RF wave 208 is done prior to receiving the backscattered RF wave 210, so as to reduce interference between the backscattered RF wave 210 and the portion 212 of the continuous RF wave 208 that is currently being transmitted by the transmitter 304.

In another example, the adjustment to the frequency of the continuous RF wave 208 is based on a frequency difference threshold. For example, where the continuous RF wave 208 is initially generated at a first frequency, the frequency adjust signal 312 may adjust the first frequency to a second frequency by the time the backscattered RF wave 210 is received at the receiver 306, where a difference between the first frequency and the second frequency is equal to or greater than the frequency difference threshold. In one example, the frequency difference threshold ensures that the second frequency of the continuous RF wave 208 currently being transmitted by the transmitter 304 is sufficiently different from the first frequency of the backscattered RF wave 210 so as to further reduce interference between the continuous RF wave 208 and the portion 212 of the continuous RF wave 208.

As shown in FIG. 3, the receiver 306 may also include a filter 310 to filter the backscattered RF wave 210 to remove the portion 212 of the continuous RF wave 208. The filter 310 is shown as receiving the backscattered RF wave 210 at the first frequency and the portion 212 of the continuous RF wave 208 at the second frequency, and generating an output 314 that is the backscattered RF wave 210 at the first frequency. In one example, the filter 310 is a bandpass filter configured to have a center frequency based on the frequency of the backscattered RF wave 210 to allow the backscattered RF wave 210 of the first frequency to pass-through to the output 314. In another example, filter 310 is a notch-filter (also referred to as a band-stop or band-rejection filter) having a center frequency based on the frequency of the continuous RF wave 208 currently being transmitted to attenuate or remove the continuous RF wave 208 of the second frequency from the output 314.

In one aspect, the bandwidth/stop band of the filter 310 is selected to remove/attenuate the continuous RF wave 208 that is currently being transmitted by transmitter 304 when the backscattered RF wave 210 is received at the receiver 306. As will be appreciated, insufficient removal/attenuation of the continuous RF wave 208 by filter 310 may result in undesirable interference or effects, such as a resultant beat frequency at output 314. In one aspect, the frequency difference threshold is based on a bandwidth/stopband of the filter 310. For example, the frequency difference threshold may be made smaller for filters 310 with a narrower bandwidth/stopband.

Referring back to FIG. 4, in one aspect, the transmitting of process block 405, the adjusting of process block 410, and the receiving of process block 415 may occur during a single transaction between the RFID reader 202 and the RFID tag 204. For example, the RFID reader 202 may be configured to transmit a message utilizing the continuous RF wave 208 during the transaction, where the RFID reader 202 receives a response to the message on the backscattered RF wave 210 after adjusting the frequency of the continuous RF wave 208.

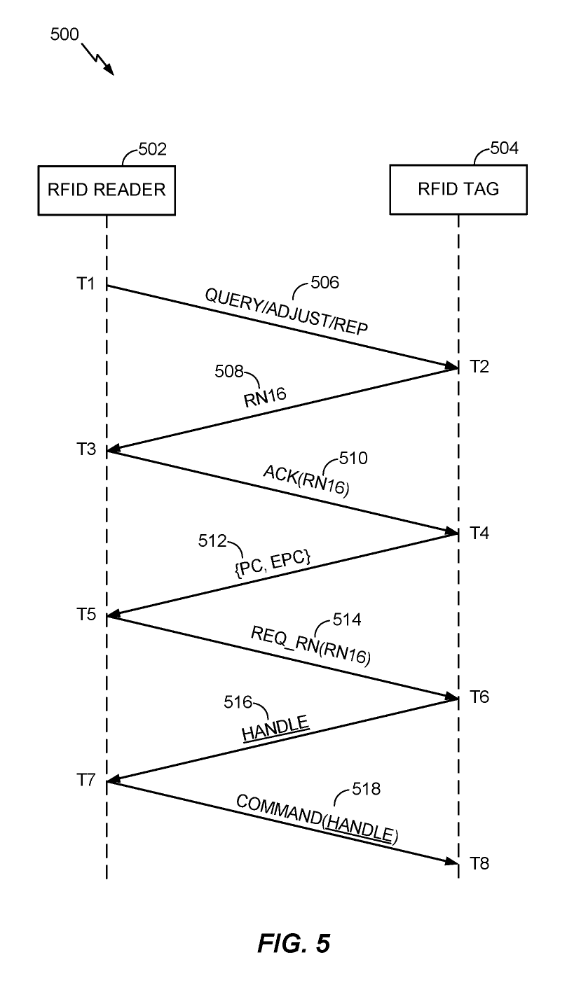

By way of example, FIG. 5 illustrates the exchange of messages during a transaction 500 between an RFID reader 502 and an RFID tag 504, according to various aspects. RFID reader 502 and RFID tag 504 are possible implementations of RFID reader 202 and RFID tag 204, respectively of FIG. 2.

At time T1, the RFID reader 502 transmits a first message 506 utilizing a continuous RF wave (e.g., continuous RF wave 208). The first message 506 may be a Query message, a QueryAdjust message, or a QueryRep message according to one or more RFID protocols. In one example, first message 506 (e.g., QueryRep) is a repetition command to talk to the next RFID tag and is configured to get the RFID tag to respond with an RN16. The RN16 is a 16 bit random or pseudo-random number configured to address the RFID tag, especially before the ID (e.g., EPC) of the RFID tag is known. At time T2, the RFID tag 504 generates a response to the first message 506, which as shown in FIG. 5 may be an RN16 message 508. The RN16 message 508 is then received at the RFID reader 502 by way of a backscattered RF wave (e.g., backscattered RF wave 210). At time T3, the RFID reader 502 acknowledges the RFID tag 504 by transmitting an ACK message 510 with the same RN16. If the RN16 message 510 includes a valid RN16, the RFID tag 504 then responds, at time T4, with a {PC, EPC} message 512. In one example, the {PC, EPC} message 512 includes data corresponding to the identification (ID) of the RFID tag 504 (e.g., electronic product code—EPC) as well as protocol control (e.g., PC). In some examples, transaction 500 may end after the RFID reader 502 receives the EPC.

However, in other examples, transaction 500 may continue with RFID reader 502 further interacting with RFID tag 504. For example, at time T5, the RFID reader 502 then transmits a REQ_RN(RN16) message 514 to the RFID tag 504. In one example, the REQ_RN(RN16) message 514 is a request for a random number, however, other request may be utilized as well. Again, if the RN16 contained in the REQ_RN(RN16) message 514 is valid, RFID tag 504 then responds at time T6 by generating a HANDLE message 516. At time T7, the RFID reader 502 then accesses the RFID tag 504 by generating one or more command messages 518 using the received handle as a parameter. The command messages 518 may include one or more commands to read other memories in the RFID tag 504 and/or commands for the RFID tag 504 to perform one or more other operations (e.g., read sensors, encryption).

Each of the above-referenced messages 506, 510, 514, and 518 are transmitted by the RFID reader 502 utilizing a continuous RF wave generated by the RFID reader 502 and each of the messages 508, 512, and 516 are received by the RFID reader 502 via a backscattered RF wave generated by the RFID tag 504. In one aspect, the RFID reader 502 is configured to adjust the frequency of the continuous RF wave after completing transmission of a message and prior to receiving a corresponding response on the backscattered RF wave. For example, RFID reader 502 may transmit the first message 506 on the continuous RF wave of a first frequency. After transmission of the first message 506 is complete and prior to receiving a response to the first message 506, (e.g., RN16 message 508), the RFID reader 502 may adjust the first frequency of the continuous RF wave to a second frequency, such that the continuous RF wave is at the second frequency when the backscattered RF wave of the first frequency carrying the RN16 message 508 is received at the RFID reader 502. As discussed above, a difference between the first frequency and the second frequency is equal to or greater than the frequency difference threshold so as to reduce interference between the backscattered RF wave and the continuous RF wave currently being transmitted by RFID reader 502.

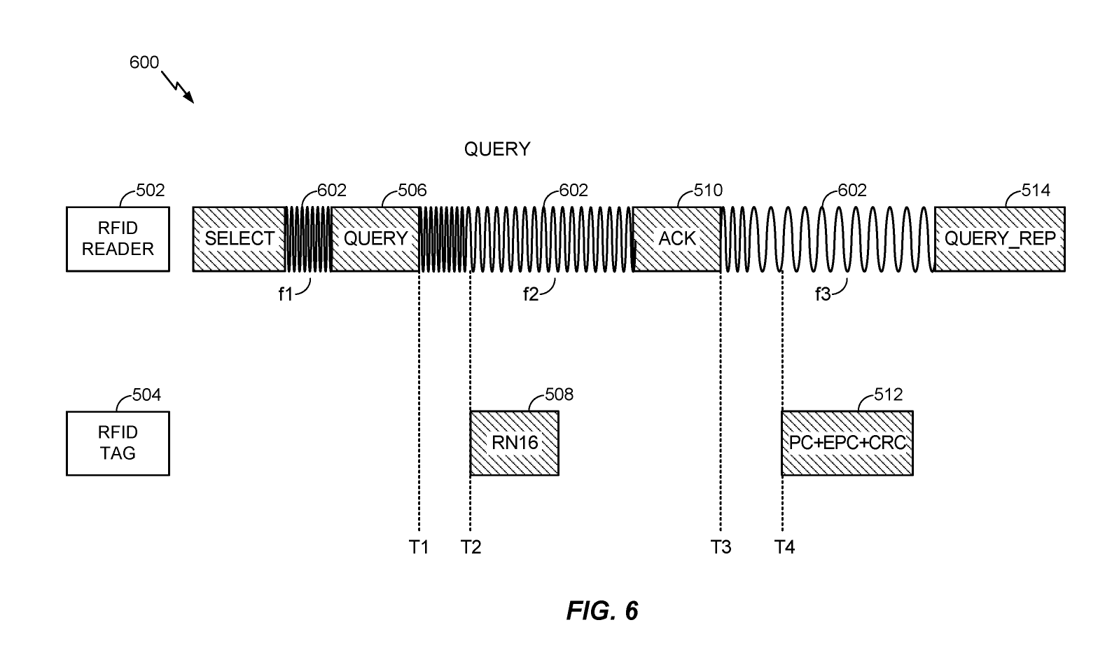

FIG. 6 illustrates the use of a continuous RF wave 602 by RFID reader 502 to exchange messages during a transaction 600 between the RFID reader 502 and the RFID tag 504, according to various aspects. The transaction 600 is an alternative visualization of at least a portion of the transaction 500 discussed above with reference to FIG. 5.

As shown in FIG. 6, each of the messages 506, 510, and 514 are transmitted by the RFID reader 502 utilizing the continuous RF wave 602. As further shown in FIG. 6, the frequency of the continuous RF wave 602 is adjusted after transmitting a message and prior to receiving a corresponding response to the message from the RFID tag 504. For example, FIG. 6 illustrates the transmission of the first message 506 as being completed at time T1 when continuous RF wave 602 is at a first frequency f1. Thus, the corresponding RN16 message 508 will be generated by the RFID tag 504 utilizing a backscattered RF wave at the first frequency f1. Prior to receiving the RN16 message 508 at time T2, the RFID reader 502 adjusts the frequency of the continuous RF wave 602 to a second frequency f2. Thus, at time T2, the frequency of the continuous RF wave 602 is at the second frequency f2 that is sufficiently different (e.g., greater than or equal to the frequency difference threshold) from the first frequency f1 of the backscattered RF wave of the RN16 message 508.

By way of another example, the RFID reader 502 may then transmit the ACK message 510 utilizing the continuous RF wave 602 at the second frequency f2. The transmission of the ACK message 510 is shown as being completed at time T3 when continuous RF wave 602 is at a second frequency f2. Thus, the corresponding {PC, EPC} message 512 will be generated by the RFID tag 504 utilizing a backscattered RF wave at the second frequency f2. Prior to receiving the {PC+EPC+CRC} message 512 at time T4, the RFID reader 502 adjusts the frequency of the continuous RF wave 602 to a third frequency f3. Thus, at time T4, the frequency of the continuous RF wave 602 is at the third frequency f3 that is sufficiently different (e.g., greater than or equal to the frequency difference threshold) from the second frequency f2 of the backscattered RF wave of the {PC, EPC} message 512.

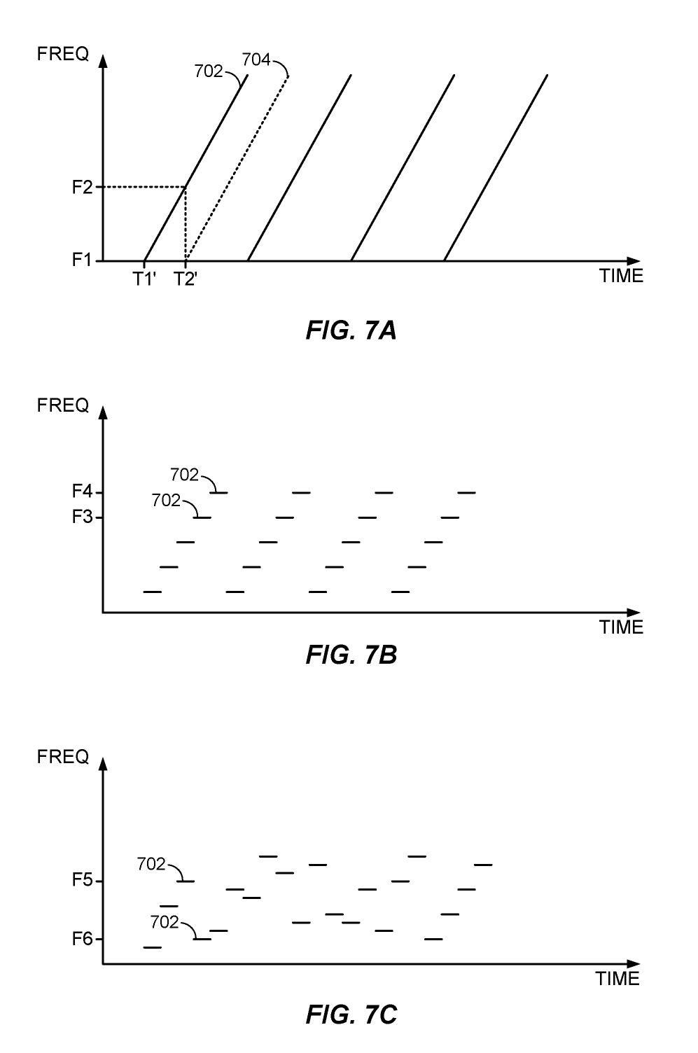

As mentioned above, adjusting the frequency of the continuous RF wave 602 may be implemented in a variety of ways in accordance with various aspects of the present disclosure. For example, FIG. 7A illustrates an example of adjusting the frequency of a continuous RF wave 702 based on a sawtooth cycle, according to various aspects. Continuous RF wave 702 is one possible implementation of continuous RF wave 208 of FIGS. 2 and 3 and/or continuous RF wave 602 of FIG. 6. In one aspect, the continuous RF wave 702 is continuously adjusted during a single transaction between an RFID reader and an RFID tag, such as transactions 500 and 600, discussed above. As shown in FIG. 7A, the continuous RF wave 702 is shown as linearly increasing from frequency F1 with time, until an upper frequency is reached, at which time the frequency of the continuous RF wave 702 is adjusted back to frequency F1.

FIG. 7A further illustrates the frequency of a corresponding backscattered RF wave 704 that is received at the RFID reader. As shown in FIG. 7A, the continuous RF wave 702 is transmitted by the RFID reader at the first frequency F1 at time T1′. At time T2′, the corresponding backscattered RF wave 704 is received at the RFID reader. As further shown in FIG. 7A, at time T2′, the backscattered RF wave 704 is at the first frequency F1, while the continuous RF wave 702 has been adjusted to a second frequency F2. In FIG. 7A, the difference between T1 and T2 may be referred to as a propagation time; specifically, the round trip time as seen from the RFID reader.

As discussed above, a difference between the first frequency F2 and the second frequency F2 may be based on a frequency difference threshold, so as to reduce interference between the continuous RF wave 702 and the backscattered RF wave 704 at time T2′. In one example, the frequency difference threshold may be maintained by the RFID reader by way of controlling a slew rate of the continuous RF wave 702. That is, by controlling the slew rate of the continuous RF wave 702 with respect to a range of the RFID tag, interference between the continuous RF wave 702 and the backscattered RF wave 704 can be mitigated (e.g., by way of filter 310 of FIG. 3).

By way of a specific example, assuming an RFID tag is about 20 meters from the RFID reader, then the round trip time (RTT) is approximately 120 ns (i.e., T2′−T1′=120 ns). Continuing with this example, the RFID reader may be capable of using 25 MHz of the ISM band and includes an analog filter (e.g., filter 310 of FIG. 3) of 1 MHz. The RFID reader may then set the slew rate of the continuous RF wave 702 to 1 MHz/100 ns. If so, then the backscattered RF wave 704 will be more than 1 MHz away from the continuous RF wave 702 at time T2 (i.e., F2-F1>1 MHz). In one example, the period of the sawtooth cycle of continuous RF wave 702 is about 400 KHz.

FIG. 7B illustrates an example of adjusting the frequency of a continuous RF wave 702 in a step-wise manner, according to various aspects. The example of FIG. 7B illustrates the adjustment of the continuous RF wave 702, where each adjustment in frequency is a step increase in frequency. For example, FIG. 7B illustrates a step increase in the continuous RF wave 702 from a frequency F3 to a frequency F4. In one aspect, each step increase in the frequency of the continuous RF wave 702 is greater than or equal to the frequency difference threshold (i.e., F4-F3≧frequency difference threshold).

FIG. 7C illustrates an example of adjusting the frequency of a continuous RF wave 702 by frequency-hopping, according to various aspects. In one example, the RFID reader may be configured to sense it's environment (e.g., wireless communications system 100) to detect the presence of other signals (e.g., due to other RFID readers, Wifi, and/or Bluetooth). In response to detecting the present of other signals in the environment, the RFID reader may then determine a subset of the available frequencies so as to further reduce interference. The example of FIG. 7C illustrates the adjustment of the continuous RF wave 702, where each adjustment is a step change in frequency where the step change may be an increase or a decrease in frequency. For example, FIG. 7C illustrates a step decrease in the continuous RF wave 702 from a frequency F5 to a lower frequency F6. In one aspect, each step change in frequency of the continuous RF wave 702 is greater than or equal to the frequency difference threshold (e.g., F5-F6≧frequency difference threshold). In some examples, the frequency hopping is performed according to a dynamically determined or a predetermined pattern of frequencies. In another example, the step change in frequency is performed randomly. That is, the RFID reader may randomly select a next frequency when adjusting the frequency of the continuous RF wave 702. In one example, the random selection of the next frequency of the continuous RF wave 702 may include randomly selecting the next frequency from a set of frequencies, where each frequency in the set of frequencies is different from one another at least by an amount determined by the frequency difference threshold.

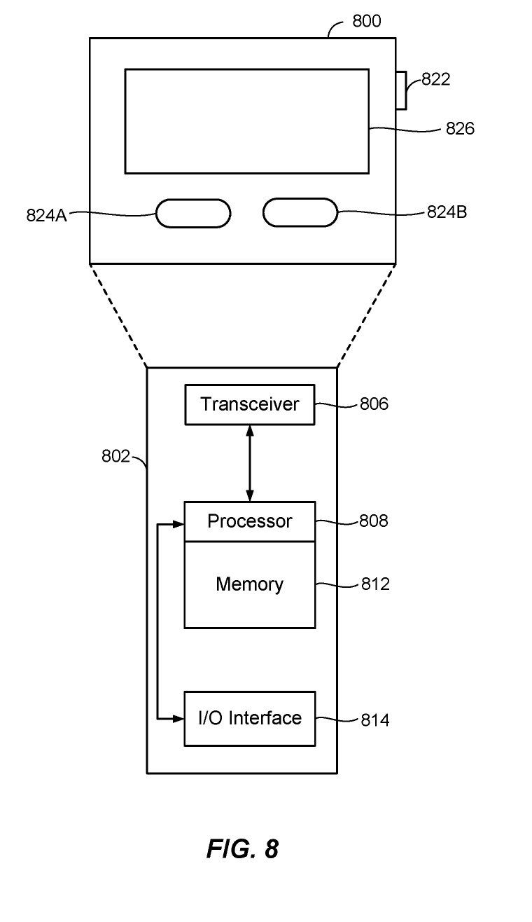

FIG. 8 illustrates an example of an RFID reader 800, according to various aspects. RFID reader 800 is one possible implementation of RFID readers 125, 202, and 502 discussed above. While external appearances and/or internal components can differ significantly among RFID readers, some RFID readers may include some sort of user interface, which may comprise a display and a means for user input. RFID readers without a user interface can be communicated with remotely over a wired or wireless network, such as via computer 120 and/or Internet 175 of FIG. 1.

As shown in FIG. 8, in an example configuration for the RFID reader 800, an external casing of RFID reader 800 may be configured with a display 826, a power button 822, and one or more control buttons 824A and 824B, among other components, as is known in the art. The display 826 may be a touchscreen display, in which case the control buttons 824A and 824B may not be necessary. While not shown explicitly as part of RFID reader 800, the RFID reader 800 may include one or more external antennas and/or one or more integrated antennas that are built into the external casing, including but not limited to RFID antennas, Wi-Fi antennas, cellular antennas, satellite position system (SPS) antennas (e.g., global positioning system (GPS) antennas), and so on.

While internal components of RFID readers, such as RFID reader 800, can be embodied with different hardware configurations, a basic high-level configuration for internal hardware components is shown as platform 802 in FIG. 8. The platform 802 can receive and execute software applications, data and/or commands transmitted over a network interface, such as from computer 120 and/or server 170 of FIG. 1 and/or a wired interface. The platform 802 can also independently execute locally stored applications. The platform 802 can include one or more transceivers 806 configured for wired and/or wireless communication. In one example, the transceiver 806 includes an RFID transceiver such as transceiver 302 of FIG. 3. The transceiver 806 may also include a Wi-Fi transceiver, a Bluetooth transceiver, a cellular transceiver, a satellite transceiver, a GPS or SPS receiver, etc., operably coupled to one or more processors 808, such as a microcontroller, microprocessor, application specific integrated circuit, digital signal processor (DSP), programmable logic circuit, or other data processing device, which will be generally referred to as processor 808. The processor 808 can execute application programming instructions within a memory 812 of the RFID reader 800. The memory 812 can include one or more of read-only memory (ROM), random-access memory (RAM), electrically erasable programmable ROM (EEPROM), flash cards, or any memory common to computer platforms. One or more input/output (I/O) interfaces 814 can be configured to allow the processor 808 to communicate with and control from various I/O devices such as the display 826, power button 822, control buttons 824A and 824B as illustrated, and any other devices, such as sensors, actuators, relays, valves, switches, and the like associated with the RFID reader 800.

Accordingly, various aspects can include an RFID reader (e.g., RFID reader 800) including the ability to perform the functions described herein. As will be appreciated by those skilled in the art, the various logic elements can be embodied in discrete elements, software modules executed on a processor (e.g., processor 808) or any combination of software and hardware to achieve the functionality disclosed herein. For example, transceiver 806, processor 808, memory 812, and I/O interface 814 may all be used cooperatively to load, store and execute the various functions disclosed herein and thus the logic to perform these functions may be distributed over various elements. Alternatively, the functionality could be incorporated into one discrete component. Therefore, the features of the RFID reader 800 in FIG. 8 are to be considered merely illustrative and the RFID reader 800 is not limited to the illustrated features or arrangement shown in FIG. 8.

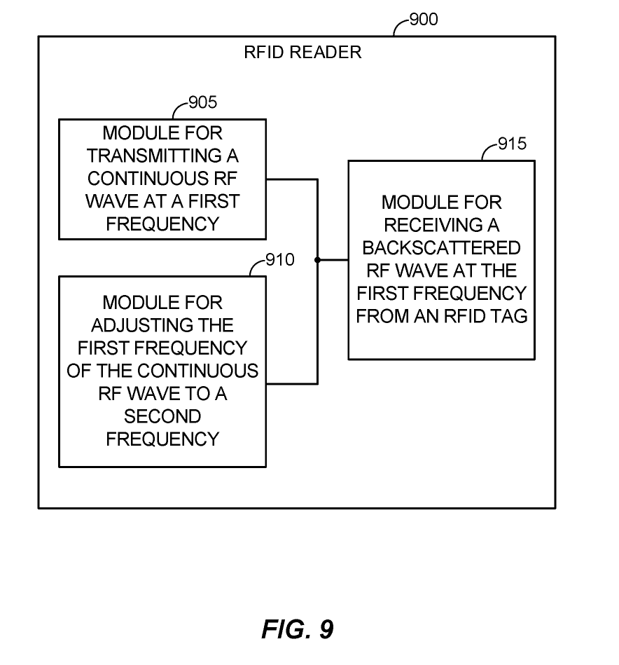

FIG. 9 illustrates an RFID reader 900 that includes various structural components configured to perform functionality, according to various aspects. The RFID reader 900 can correspond to any of the RFID readers described in further detail above, including but not limited to any one or more of the RFID readers 125, 202, and 502 discussed above.

A module 905 for transmitting a continuous RF wave at a first frequency may correspond at least in some aspects to, for example, transceiver 206 of FIG. 2, transmitter 304 of FIG. 3, and/or transceiver 806 of FIG. 8. A module 910 for adjusting the first frequency of the continuous RF wave to a second frequency may correspond at least in some aspects to, for example, transceiver 206 of FIG. 2, transmitter 304 of FIG. 3, frequency adjust circuit 308 of FIG. 8, processor 808 of FIG. 8, and/or transceiver 806 of FIG. 8. A module 915 for receiving a backscattered RF wave at the first frequency from an RFID tag may correspond at least in some aspects to, for example, transceiver 206 of FIG. 2, receiver 306 of FIG. 3, and/or transceiver 806 of FIG. 8.

The functionality of the modules 905-915 may be implemented in various ways consistent with the teachings herein. In some designs, the functionality of modules 905-915 may be implemented as one or more electrical components. In some designs, the functionality of modules 905-915 may be implemented as a processing system including one or more processor components. In some designs, the functionality of modules 905-915 may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 9, as well as other components and functions described herein, may be implemented using any suitable means. Such means also may be implemented, at least in part, using corresponding structure as taught herein. For example, the components described above in conjunction with the “module for” components of FIG. 9 also may correspond to similarly designated “means for” functionality. Thus, in some aspects, one or more of such means may be implemented using one or more of processor components, integrated circuits, or other suitable structure as taught herein.

Further, those of skill in the art will appreciate that the various illustrative logical blocks, modules, circuits, and algorithm steps described in connection with the embodiments disclosed herein may be implemented as electronic hardware or a combination of computer software and electronic hardware. To clearly illustrate this interchangeability of hardware and hardware-software combinations, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a non-transitory computer-readable media embodying a process for the communicating by an RFID reader, as discussed above with reference to process 400 of FIG. 4. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

While the foregoing disclosure shows illustrative aspects and embodiments, those skilled in the art will appreciate that various changes and modifications could be made herein without departing from the scope of the disclosure as defined by the appended claims. The functions, steps and/or actions of the method claims in accordance with the aspects and embodiments described herein need not be performed in any particular order. Furthermore, although elements may be described above or claimed in the singular, the plural is contemplated unless limitation to the singular is explicitly stated.

What is claimed is:

1. A method of communicating by a Radio Frequency Identification (RFID) reader, the method comprising:
transmitting, by the RFID reader, a continuous radio frequency (RF) wave at a first frequency;
adjusting, by the RFID reader, the first frequency of the continuous RF wave to a second frequency; and then
receiving a backscattered RF wave at the first frequency from an RFID tag, the backscattered RF wave generated by the RFID tag in response to the continuous RF wave of the first frequency, wherein a difference between the first frequency and the second frequency is equal to or greater than a frequency difference threshold to reduce interference between the backscattered RF wave and the continuous RF wave.

2. The method of claim 1, wherein receiving the backscattered RF wave at the first frequency comprises filtering the backscattered RF wave to remove the continuous RF wave of the second frequency.

3. The method of claim 1, wherein the transmitting, the adjusting, and the receiving occur during a single transaction between the RFID reader and the RFID tag.

4. The method of claim 3, further comprising:
transmitting a message, by the RFID reader, of the single transaction between the RFID reader and the RFID tag, utilizing the continuous RF wave of the first frequency; and
receiving a response to the message of the single transaction on the backscattered RF wave of the first frequency after adjusting the first frequency of the continuous RF wave to the second frequency.

5. The method of claim 3, further comprising continuously adjusting the first frequency of the continuous RF wave during the single transaction between the RFID reader and the RFID tag.

6. The method of claim 5, wherein continuously adjusting the first frequency comprises continuously adjusting the first frequency of the continuous RF wave based on a sawtooth cycle.

7. The method of claim 3, further comprising adjusting the first frequency of the continuous RF wave in a step-wise manner during the single transaction between the RFID reader and the RFID tag.

8. The method of claim 3, wherein adjusting the first frequency of the continuous RF wave comprises randomly selecting a next frequency of the continuous RF wave during the single transaction between the RFID reader and the RFID tag.

9. The method of claim 3, wherein adjusting the first frequency of the continuous RF wave comprises frequency-hopping the first frequency of the continuous RF wave during the single transaction between the RFID reader and the RFID tag.

10. The method of claim 1, further comprising:
determining a transmit power of the continuous RF wave, wherein the adjusting of the first frequency of the continuous RF wave is in response to the transmit power.

11. The method of claim 10, further comprising:
adjusting the first frequency of the continuous RF wave to the second frequency in response to the transmit power being greater than or equal to a power threshold; and
maintaining the continuous RF wave at the first frequency in response to the transmit power being less than the power threshold such that the continuous RF wave is at the first frequency when the backscattered RF wave of the first frequency is received.

12. A Radio Frequency Identification (RFID) reader, comprising:
a transceiver configured to:
transmit a continuous radio frequency (RF) wave at a first frequency;
adjust the first frequency of the continuous RF wave to a second frequency; and then
receive a backscattered RF wave at the first frequency from an RFID tag, the backscattered RF wave generated by the RFID tag in response to the continuous RF wave of the first frequency, wherein a difference between the first frequency and the second frequency is equal to or greater than a frequency difference threshold to reduce interference between the backscattered RF wave and the continuous RF wave.

13. The RFID reader of claim 12, wherein the transceiver is further configured to filter the backscattered RF wave to remove the continuous RF wave of the second frequency.

14. The RFID reader of claim 12, wherein the transceiver is further configured to:
transmit a message of a single transaction between the RFID reader and the RFID tag, utilizing the continuous RF wave of the first frequency; and
receive a response to the message of the single transaction on the backscattered RF wave of the first frequency after adjusting the first frequency of the continuous RF wave to the second frequency.

15. The RFID reader of claim 12, wherein the transceiver is further configured to continuously adjust the first frequency of the continuous RF wave during a single transaction between the RFID reader and the RFID tag.

16. The RFID reader of claim 15, wherein the transceiver is further configured to continuously adjust the first frequency of the continuous RF wave based on a sawtooth cycle during the single transaction between the RFID reader and the RFID tag.

17. The RFID reader of claim 12, wherein the transceiver is further configured to adjust the first frequency of the continuous RF wave in a step-wise manner during a single transaction between the RFID reader and the RFID tag.

18. The RFID reader of claim 12, wherein the transceiver is further configured to adjust the first frequency of the continuous RF wave by randomly selecting a next frequency of the continuous RF wave during a single transaction between the RFID reader and the RFID tag.

19. The RFID reader of claim 12, wherein the transceiver is further configured to adjust the first frequency of the continuous RF wave by frequency-hopping the first frequency of the continuous RF wave during a single transaction between the RFID reader and the RFID tag.

20. The RFID reader of claim 12, wherein the transceiver is further configured to:
determine a transmit power of the continuous RF wave; and
adjust the first frequency of the continuous RF wave in response to the transmit power.

21. The RFID reader of claim 20, wherein the transceiver is further configured to:
adjust the first frequency of the continuous RF wave to the second frequency in response to the transmit power being greater than or equal to a power threshold; and
maintain the continuous RF wave at the first frequency in response to the transmit power being less than the power threshold such that the continuous RF wave is at the first frequency when the backscattered RF wave of the first frequency is received.

22. A Radio Frequency Identification (RFID) reader, comprising:
means for transmitting a continuous radio frequency (RF) wave at a first frequency;
means for adjusting the first frequency of the continuous RF wave to a second frequency; and
means for receiving a backscattered RF wave at the first frequency from an RFID tag, the backscattered RF wave generated by the RFID tag in response to the continuous RF wave of the first frequency, wherein a difference between the first frequency and the second frequency is equal to or greater than a frequency difference threshold to reduce interference between the backscattered RF wave and the continuous RF wave.

23. The RFID reader of claim 22, further comprising means for filtering the backscattered RF wave to remove the continuous RF wave of the second frequency.

24. The RFID reader of claim 22, further comprising:
means for transmitting a message of a single transaction between the RFID reader and the RFID tag, utilizing the continuous RF wave of the first frequency; and
means for receiving a response to the message of the single transaction on the backscattered RF wave of the first frequency after adjusting the first frequency of the continuous RF wave to the second frequency.

25. A non-transitory computer-readable storage medium including computer-executable instructions recorded thereon, wherein executing the computer-executable instructions on one or more processors of a Radio Frequency Identification (RFID) reader causes the RFID reader to perform operations, comprising:
transmit a continuous radio frequency (RF) wave at a first frequency;
adjust the first frequency of the continuous RF wave to a second frequency; and
then
receive a backscattered RF wave at the first frequency from an RFID tag, the backscattered RF wave generated by the RFID tag in response to the continuous RF wave of the first frequency, wherein a difference between the first frequency and the second frequency is equal to or greater than a frequency difference threshold to reduce interference between the backscattered RF wave and the continuous RF wave.

26. The non-transitory computer-readable storage medium of claim 25, further comprising at least one instruction to cause the RFID reader to filter the backscattered RF wave to remove the continuous RF wave of the second frequency.

27. The non-transitory computer-readable storage medium of claim 25, further comprising at least one instruction to cause the RFID reader to:
transmit a message of a single transaction between the RFID reader and the RFID tag, utilizing the continuous RF wave of the first frequency; and
receive a response to the message of the single transaction on the backscattered RF wave of the first frequency after adjusting the first frequency of the continuous RF wave to the second frequency.

28. The non-transitory computer-readable storage medium of claim 27, further comprising at least one instruction to cause the RFID reader to continuously adjust the first frequency of the continuous RF wave during the single transaction between the RFID reader and the RFID tag.

29. The non-transitory computer-readable storage medium of claim 28, further comprising at least one instruction to cause the RFID reader to continuously adjust the first frequency of the continuous RF wave based on a sawtooth cycle during the single transaction between the RFID reader and the RFID tag.

30. The non-transitory computer-readable storage medium of claim 25, further comprising at least one instruction to cause the RFID reader to:
determine a transmit power of the continuous RF wave;
adjust the first frequency of the continuous RF wave to the second frequency in response to the transmit power being greater than or equal to a power threshold; and
maintain the continuous RF wave at the first frequency in response to the transmit power being less than the power threshold such that the continuous RF wave is at the first frequency when the backscattered RF wave of the first frequency is received.
